(19) United States
(12) Patent Application Publication
(10) Pub. No.: US 2012/0125571 A1
(43) Pub. Date: May 24, 2012

(54) Heat-Dissipating Device for Space-Based Equipment, Notably for a Satellite

(75) Inventors: Martine Lutz, Frejus (FR); Yann Vitupier, Mougins (FR); Florence Montredon, La Roquette sur Siagne (FR); Alain Chaix, Mandelieu-La Napoule (FR); Hubert Lalande, Cannes-La-Bocca (FR)

(73) Assignee: THALES, Neuilly-sur-Seine (FR)

(21) Appl. No.: 13/112,657

(22) Filed: May 20, 2011

(30) Foreign Application Priority Data
May 21, 2010 (FR) FR1002159

(51) Int. Cl. F28F 7/00; F28D 15/02; B82Y 30/00

(52) U.S. Cl. 165/104.21; 165/185; 977/742; 977/932

(57) ABSTRACT

A device for dissipating heat, for a space-based satellite, includes at least one dissipating panel, the dissipating panel having at least one skin formed from a composite structure comprising an organic resin and carbon fibers, wherein the organic resin is filled with carbon nanotubes. The heat-dissipating device may also comprise a network of heat pipes. The heat pipes may be made from an aluminum alloy incorporating elements having low coefficients of thermal expansion. The present invention is notably applicable to fixed dissipating panels or those that may be used in telecommunications, observation or scientific satellites, or else on racks assembled to dissipating panels.

### CROSS-REFERENCE TO RELATED APPLICATION

This application claims priority to foreign French patent application No. FR 1002159, filed on May 21, 2010, the disclosure of which is incorporated by reference in its entirety.

### FIELD OF THE INVENTION

The present invention relates to a device for dissipating heat for space-based equipment, notably for use in satellites. It is for example applicable to the space field, and more particularly to telecommunications, observation or scientific satellites.

### BACKGROUND

Devices for space-based applications must meet increasingly strict performance-based criteria. As regards telecommunications satellites, the latter carry an ever greater number of ever more complex pieces of equipment that consume an ever greater amount of energy, consequently producing more heat. Thus, telecommunications satellites must be able to effectively dissipate the heat produced by the equipment carried, so as to guarantee the long-term performance of the latter. In parallel, the increasing number of pieces of equipment carried, and economical factors, require that the components carried must meet increasingly strict weight constraints.

Telecommunications satellites often use heat sinks in the form of dissipating panels, conventionally called “North and South panels” or even “North and South walls”, because of their particular location on the surface of the satellites. North and South walls are typically composed of panels and heat conducting devices, the latter being conventionally called heat pipes, generally formed from a network of tubular structures within which a coolant flows. As regards most actual satellite systems, the structure of the North and South walls is typically made of aluminum. Likewise, the heat pipes are typically made of aluminum. Aluminum is preferred because it has good thermal-conductivity properties and physical properties that make it easier to extrude, extrusion being a manufacturing method particularly suited to obtaining tubular structural parts. Furthermore, aluminum is known for its lightness.

Telecommunications satellites may also use racks, supporting equipment and heat-transfer means allowing heat given off by the equipment to be transferred to dissipating panels such as North/South panels, for example. Similarly, the components forming the racks are preferably made of aluminum.

As regards observation and scientific satellites, particular missions requiring both rigid structures and panels controlled thermally by heat pipes may be envisioned, notably for exploring hot planets and the Sun. The present invention may also apply when conceiving such missions.

In order to satisfy as best as possible the aforementioned constraints, and notably constraints relating to system weight, the use of alternative structures to the known aluminum structures is envisioned. The use of composites having lower masses is notably envisioned. Notably, carbon-based composite structures are envisioned. This is because recent developments have made it possible to produce composite structures containing graphite-enriched, or “graphitized”, carbon fibers. Such fibers offer very satisfactory characteristics in terms of heat conduction. Composite structures incorporating graphitized carbon fibers are thus envisioned, notably for producing the structure forming the plane of satellite North/South panels, for which good thermal conductivity properties are sought.

According to known prior-art techniques, the use of highly-graphitized carbon fibers may be combined with the use of a second type of “high-strength” carbon fiber that makes up for the insufficient mechanical strength of the first type. Typically, the first, conductive, fiber may be placed substantially perpendicular to the main axis of the heat pipes, and the second, high-strength, fiber may be placed substantially along the main axis of the heat pipes. Thus, a succession of layers comprising highly graphitized carbon fibers embedded in a resin, and layers comprising high-strength carbon fibers aligned substantially perpendicular to the fibers of the neighboring layers, may be produced. It is also possible to alternate layers in which carbon fibers are placed at a defined angle, for example 45°, to fibers placed in neighboring layers; such a configuration, formed from a superposition of layers comprising fibers of heterogeneous nature, allows composite structures to be obtained the isotropic properties of which are improved.

However, the use of highly graphitized fibers also gives the structures within which they are integrated a high stiffness modulus and a negative expansion coefficient. Thus structures incorporating such materials are difficult to manufacture industrially, and their use in applications has in practice proved to be very costly.

In addition, the use of composite structures based on graphitized carbon fibers, for example to form the plane of panels or to form racks, requires that essentially similar composite structures be used to produce the heat pipes. This is because it is desirable for the structures of the panels or the racks and of the heat pipes to have similar characteristics, notably concerning thermal expansion or thermoelasticity. Specifically, systems used in space-based applications are subject to large temperature variations, causing intense mechanical stress at the interfaces between structures of heterogeneous nature. However, producing carbon-based heat pipes has proved to be very difficult in practice, since carbon has a porosity which is a priori incompatible with the circulation of a coolant. It should furthermore be noted that the use of graphitized carbon fibers increases problems related to thermoelasticity by increasing the stiffness modulus of the structures.

Finally, in known prior-art solutions, the carbon fibers may for example be embedded in an organic resin, for example an epoxy resin. However, the use of an organic resin counteracts the improved thermal conductivity provided by the graphitized carbon fibers. Known prior-art solutions propose to replace organic resins with more thermally conductive resins; however, these resins must be processed at very high temperatures, consequently requiring very complicated and difficult manufacturing processes that are therefore expensive to implement.

### SUMMARY OF THE INVENTION

The present invention obviates at least the aforementioned drawbacks by proposing a device for dissipating heat for a space-based application, notably for a satellite, comprising a particular configuration of at least one heat pipe and at least one dissipating panel giving the heat-dissipating device an optimal thermal conductivity, mechanical-stress withstand and thermoelasticity and a particularly low weight.

One advantage of the invention is that the heat-dissipating device according to one embodiment of the invention may be easily produced using common methods of manufacture.

For this purpose, one subject of the invention is a device for dissipating heat, notably for a space-based application, comprising at least one dissipating panel, the dissipating panel comprising at least one skin formed from a composite structure comprising an organic resin and carbon fibers, wherein the organic resin is filled with carbon nanotubes.

In one embodiment of the invention, the composite structure may be formed from an alternating succession of layers comprising a first plurality of carbon fibers, placed with one defined alignment, and layers comprising a second plurality of carbon fibers, placed with an alignment substantially perpendicular to the alignment of said first plurality of carbon fibers.

In another embodiment of the invention, the composite structure may be formed from a fabric produced by entangling a first plurality of carbon fibers, placed with a defined alignment, and a second plurality of carbon fibers, placed with an alignment substantially perpendicular to the alignment of said first plurality of carbon fibers.

In another embodiment of the invention, the skin may be assembled to a network of heat pipes.

In another embodiment of the invention, the dissipating panel may comprise a planar internal skin and a planar external skin placed parallel to each other and rigidly connected using structural elements.

In another embodiment of the invention, the structural elements may be formed from a honeycomb configuration of aluminum tubes.

In another embodiment of the invention, the structural elements may be formed by a conductive foam.

In another embodiment of the invention, the network of heat pipes may be placed externally to the dissipating panel, on the surface of the internal skin.

In another embodiment of the invention, the network of heat pipes may be placed internally to the dissipating panel, between the internal skin and the external skin.

In another embodiment of the invention, the network of heat pipes may comprise one or a plurality of substantially tubular, aluminum heat pipes.

In another embodiment of the invention, the network of heat pipes may comprise one or a plurality of substantially tubular heat pipes formed from an aluminum alloy incorporating elements having low coefficients of thermal expansion.

In another embodiment of the invention, the elements incorporated in the aluminum alloy may be formed from a ceramic made of silicon carbide SiC or else of silicon nitride Si₃N₄.

In another embodiment of the invention, the elements incorporated in the aluminum alloy may be formed from silicon Si.

In another embodiment of the invention, the elements incorporated in the aluminum alloy may be formed from a ZrW₂O₈ ceramic.

In another embodiment of the invention, the elements incorporated in the aluminum alloy may be formed from β-eucryptite.

In another embodiment of the invention, the heat pipes may be assembled to the skins by means of the carbon-nanotube-enriched organic resin.

Another subject of the present invention is a fixed dissipating panel, for a satellite, formed from at least one heat-dissipating device of one of the embodiments described above.

Another subject of the present invention is a deployable dissipating panel for a satellite, formed from at least one heat-dissipating device of one of the embodiments described above.

Another subject of the present invention is a rack joined to a dissipating panel, for a satellite, formed from at least one heat-dissipating device of one of the embodiments described above.

### BRIEF DESCRIPTION OF THE DRAWINGS

Other features and advantages of the invention will become clear on reading the description, given by way of example, made with regard to the appended drawings, which show:

FIG. 1, a perspective view illustrating a known heat-dissipating device structure for a telecommunications satellite;

FIGS. 2a and 2b, cross-sectional views illustrating the structure of a heat-dissipating device comprising a dissipating panel and a network of heat pipes, in a first embodiment;

FIG. 3, a cross-sectional view illustrating the structure of a heat-dissipating device comprising a dissipating panel and a network of heat pipes, in a second embodiment; and

FIGS. 4a and 4b, cross sections through a composite composition forming a dissipating panel according to one of the embodiments of the present invention, at various magnifications.

### DETAILED DESCRIPTION

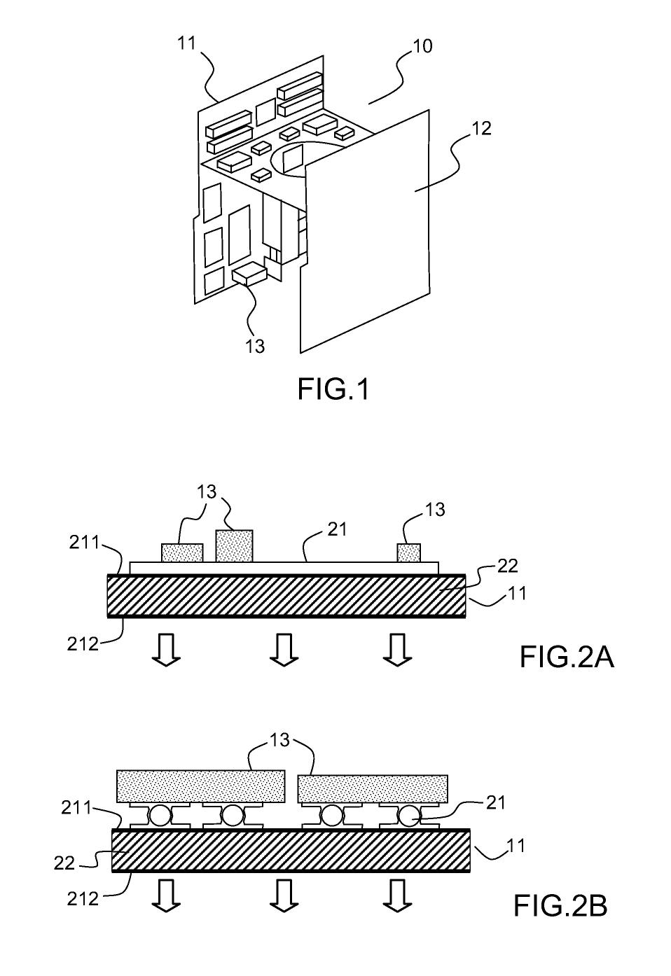

FIG. 1 shows a perspective view illustrating a known heat-dissipating device structure for a telecommunications satellite.

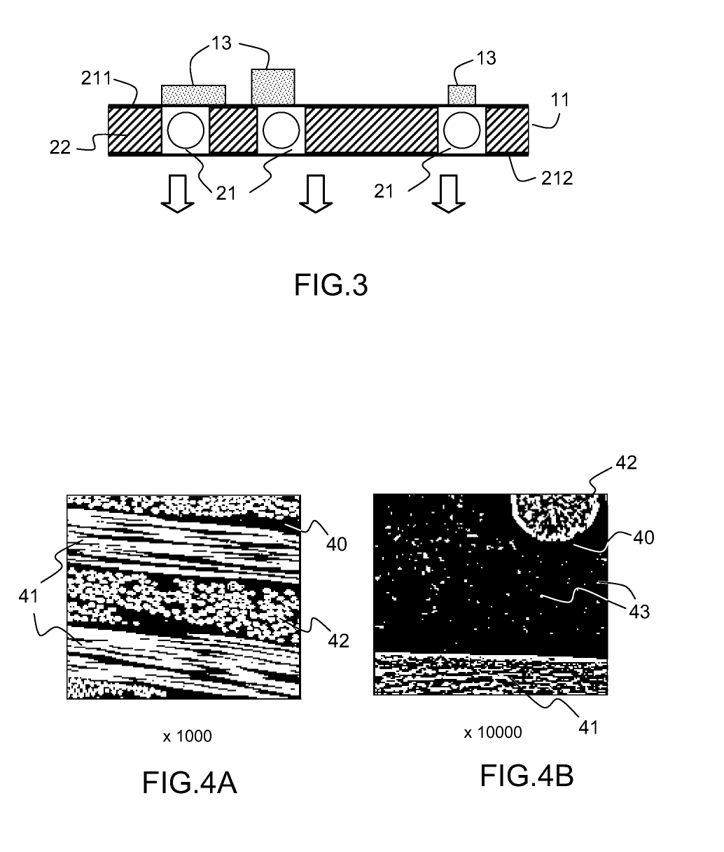

Typically, a communications satellite notably comprises a communication module 10. The communication module 10 comprises a plurality of highly dissipative electronic equipment 13. The electronic equipment 13 is installed on networks of heat pipes that are not shown in the present figure but that are described in detail below with reference to FIGS. 2a, 2b and 3. The electronic equipment 13 is placed inside the communications satellite. The heat pipes are placed on the internal surface of dissipating panels 11, 12, or else inside the dissipating panels 11, 12. The networks of heat pipes allow the thermal power to be transported or distributed over the entire area of the dissipating panels 11, 12. The external surface of the dissipating panels 11, 12 then radiates this power into the surrounding space. To improve the radiation of thermal power, the external surfaces of the dissipating panels 11, 12 are for example covered with what are commonly referred to as optical solar reflectors (OSRs). The structure of the North and South panels is described in detail below with reference to FIGS. 2a, 2b and 3.

FIGS. 2a and 2b show cross-sectional views illustrating the structure of a heat-dissipating device comprising a dissipating panel and a network of heat pipes, in a first embodiment.

In the first embodiment, a network of heat pipes comprising at least one heat pipe 21 may be placed inside a dissipating panel 11. The internal and external surfaces of the North and South panel 11 may be formed from two surface structures or “skins”, respectively an internal skin 211 and an external skin 212, defining planes that are substantially parallel to each other. The skins 211, 212 may be rigidly connected using structural elements 22. The structural elements 22 may for example typically form what is called a “honeycomb” structure. The electronic equipment 13 is placed on the network of heat pipes 21. In the example illustrated in FIG. 2a, an essentially tubular heat pipe is shown in cross section. In the example illustrated in FIG. 2b, several cross sections of the same heat pipe, or else several heat pipes, are shown in a cross-sectional view. A coolant flows in the heat pipes 21. Typically in applications such as telecommunications satellites the coolant used is ammonia.

In typical known prior-art structures, the heat pipes 21, the skins 211, 212 and the structural elements forming the dissipating panels 11 may be made of aluminum.

FIG. 3 is a schematic representation of the construction of a dissipating panel according to a second embodiment.

FIG. 3 shows a known prior-art dissipating panel structure 11 within which the networks of heat pipes 21 are integrated (appearing in cross section in the figure). In such a structure, the electronic equipment 13 may be placed directly on a skin 211, 212, substantially above the networks of heat pipes 21, the networks of heat pipes 21 being placed between the two skins 211, 212 of the dissipating panel 11 so that the skins 211, 212 provide a structural function. Similarly to the structures described above with reference to FIGS. 2a and 2b, structural elements 22, for example forming a honeycomb structure, can rigidly connect the assembly.

In the various typical configurations described above, all the materials must be light and thermally conductive. Furthermore, the materials used must have physical properties such that manufacture of the component parts of the structure is possible and achievable at a low cost. Finally, the materials used must have properties, notably thermoelastic properties, that are sufficiently homogeneous that the stresses applied, particularly to the interfaces between the various elements, do not cause splits or changes that prejudice the aforementioned required properties. Also, these properties must be preserved over the entire lifetime of the devices, typically more than fifteen years for space-based applications. For all these reasons, aluminum is widely used for all the elements forming the dissipating panels, i.e. the networks of heat pipes 21, the skins 211, 212 and the structural elements 22.

The present invention may be applied indifferently to various dissipating-panel configurations, within or external to which are placed networks of heat pipes, such as for example the configurations described above with reference to FIGS. 2a, 2b and 3. The present invention proposes the use of a composite-based structure for the skins 211, 212, this structure notably offering both an improved weight and a thermal conductivity suited to space-based applications. More precisely, the present invention proposes to use a carbon-fabric structure for the skins 211, 212, i.e. a structure comprising an organic resin, for example an epoxy resin, filled with carbon fibers. The carbon fibers are graphitized fibers, for example “ex-pitch” carbon fibers, providing thermal-conductivity properties to the resin, the latter being by nature thermally nonconductive. It is for example possible to form the carbon-fiber filler using multiwall carbon nanofibers, commonly called multiwalled nanotubes (MWNTs). These nanofibers may for example be approximately 80 nm in diameter, and may be purified—impurities, due to the method used to produce the nanofibers, preventing heat flux flow. Purification of the nanofibers may be achieved using a heat treatment, and allows the degree of alignment of the graphene layers to be increased and the space between these layers to be decreased, thereby increasing the efficiency with which phonons and electrons are transported—the origin of the increased thermal conductivity. This is because the thermal conductivity of a material is the sum of a number of forms of thermal conduction. Each form of thermal conduction is connected with a type of heat carrier, or quanta. These quanta are mainly acoustic and optical phonons, connected with mechanical waves in the lattice caused by vibration of the atoms. The amount of nanofiber filler may for example be from about 5 to about 15%.

In order to reduce the thermal-conductivity demands placed on the carbon fibers, with the object of reducing their stiffness modulus, the present invention proposes to give the organic resin a better thermal conductivity. To do this, the present invention proposes to fill the organic resin with carbon nanotubes, so as to give the skins 211, 212 a good in-plane thermal conductivity. It is for example possible to incorporate carbon nanotubes into an industrial resin that has been previously qualified for space-based applications. The composition of the resin is described in detail below with reference to FIGS. 4a and 4b. Thus, the present invention enables a judicious coupling of highly graphitized ex-pitch carbon fibers and carbon nanotubes, this coupling providing a compromise between good thermal-conductivity properties and a reasonably high stiffness modulus.

Advantageously, it is possible to fill the organic resin with carbon nanotubes so that the thermal conductivity of the composite structure in the plane of the skins 211, 212, approaches the thermal conductivity of aluminum, and therefore to use aluminum-based heat pipes, for example having known prior-art structures, without the fundamental heterogeneity of the materials used leading to fundamental differences in terms of thermal conductivity. For example, the resin may be filled with highly purified carbon nanotubes. The degree of impurities in the nanotubes may significantly affect their properties. It is for example possible to use nanofibers that have been highly purified using a high-temperature heat treatment, allowing the degree of alignment of the graphene layers to be increased and the space between these layers to be decreased, so as to increase the efficiency with which phonons and electrons are transported—the origin of the increased thermal conductivity. The amount of filler may for example be chosen to be about the same as the percolation threshold of the resin, i.e. the amount at which the thermal conductivity approaches an asymptote. The amount of filler may for example be chosen to be about 10%.

Advantageously, it is possible to give the aluminum-based structure forming the heat pipes 21 a coefficient of thermal expansion that is sufficiently near to the coefficient of thermal expansion of the composite structure forming the skins 211, 212 that the fundamental heterogeneity of the materials used does not lead to greater thermoelastic stresses, for example under the effect of large temperature variations. To this end, it is for example also possible to use a composite material for the heat pipes 21. The composite material must not complicate industrial manufacture. Notably, it is possible to use composite alloys that preserve the main advantages of aluminum, i.e. a low density and a good thermal conductivity, but with a reduced coefficient of thermal expansion. It is for example possible to use an aluminum-based alloy, and additives having a low coefficient of thermal expansion. More precisely, it is for example possible to use additives such as ceramics made of silicon carbide SiC or else of silicon nitride Si₃N₄, or else metallic silicon Si, the coefficients of thermal expansion of which typically lie between 1 and 2.5 ppm/° C. at room temperature. It is also possible to envision using any known additives having a coefficient of thermal expansion of this order or even of a lower order, whose incorporation into aluminum may reasonably be envisioned. It is notably possible to envision using additives having a negative coefficient of thermal expansion, such as for example ZrW₂O₈-based ceramics, or else β-eucryptite. The extrusion properties of the aluminum-based alloy may be modified by varying the particle size of the additive fillers. It is for example possible to incorporate submicron-sized or even nanoscale particles of silicon carbide SiC into the aluminum so as to reinforce the extrudable nature of the alloy. For example it is possible to envision a proportion of 20 to 30% silicon carbide in the alloy. The choice of an aluminum alloy furthermore has the advantage of giving the heat pipes 21 a long-term compatibility with ammonia, when this is the coolant that they contain.

Advantageously, it is possible to make use of the self-adhesive property of the resin filled with carbon nanotubes, and to use it for example as an adhesive, notably between the heat pipes 21 and the skins 211, 212. This embodiment has the advantage of ensuring homogeneity between the elements forming the dissipating panel and the elements ensuring the assembly of the latter.

Advantageously, it is possible to substitute a light conductive foam for the structural elements 22. A foam may then be used to position the heat pipe 21 in the dissipating panel 11, 12. It is for example possible to choose a thermally conductive, low-density foam that provides a good contact to the heat pipe 21. It is for example possible to use a hybrid, carbon or aluminum epoxy, foam. Such an embodiment reduces weight and increases thermal conductivity in the transverse direction, i.e. through the thickness of the dissipating panel.

It should be noted that the devices for dissipating heat, presented in the various embodiments given by way of example and described above, may form dissipating panels, but also structures joined to dissipating panels, such as racks.

Also, the heat-dissipating devices according to the various embodiments presented may not only form fixed dissipating panels but also be included in deployable dissipating panels. Prior-art deployable dissipating-panel structures are known. Deployable dissipating panels may be stowed in a “folded” configuration during the launch phase of a satellite and deployed once the satellite is in orbit, allowing the overall radiating area of the satellite to be substantially increased. A circuit of heat pipes or of smooth tubes may be mounted on the deployable dissipating panel, and a system of fluid loops may be connected to the dissipating panel, for example via a tubular structure made of stainless steel, compatible with the low coefficient of thermal expansion of the dissipating pane.

FIGS. 4a and 4b each show a cross section through a composite composition forming a dissipating panel according to one of the embodiments of the present invention, at various magnifications.

FIG. 4a illustrates a cross section of the composite composition at a magnification of ×1000. In the example illustrated in FIGS. 4a and 4b, the composite material may be formed within a resin 40, by an alternation of a layer formed from a first plurality of carbon fibers 41, the fibers being placed substantially along the main axis of the heat pipes, and a layer formed from a second plurality of carbon fibers 42, the fibers being placed substantially perpendicular to the plurality of carbon fibers 41. One advantage of this embodiment is that the various layers forming the composite structure are by nature homogeneous. This is because, the joint use of carbon fibers and filled resin allows the best compromise to be obtained between thermal conductivity, expansion, stiffness and strength properties.

Also, in another embodiment of the invention, it is possible for the carbon fibers 41, 42 to take the form of a fabric, the fabric being formed by entangling the first plurality of carbon fibers 41, then placed in the “warp”, and the second plurality of carbon fibers 42, then placed in the “weft”, the two pluralities of carbon fibers 41, 42 being substantially perpendicular to each other. A fabric structure enables a thickness saving, and therefore both a weight saving and a volume saving, to be achieved.

Also, with the object of giving the composite structure better isotropic properties, it is possible to place the carbon fibers in successive layers, or even within a fabric structure, at a defined angle to each other, for example 45°

FIG. 4b illustrates a cross section of the composite composition at a magnification of about ×10,000. In the example illustrated in FIG. 4b, within the resin 40, a plurality of warp carbon fibers 41 may be seen in addition to one of the weft carbon fibers 42. Furthermore, carbon nanotubes 43 fill the resin 40.

1- A device for dissipating heat, for a space-based satellite, comprising:
at least one dissipating panel, the dissipating panel comprising at least one skin formed from a composite structure comprising an organic resin and carbon fibers, said organic resin being filled with carbon nanotubes.

2- The device for dissipating heat as claimed in claim 1, wherein the composite structure is formed from an alternating succession of layers comprising a first plurality of carbon fibers, placed with one defined alignment, and layers comprising a second plurality of carbon fibers, placed with an alignment substantially perpendicular to the alignment of said first plurality of carbon fibers.

3- The device for dissipating heat as claimed in claim 1, wherein the composite structure is formed from a fabric produced by entangling a first plurality of carbon fibers, placed with a defined alignment, and a second plurality of carbon fibers, placed with an alignment substantially perpendicular to the alignment of said first plurality of carbon fibers.

4- The device for dissipating heat as claimed in claim 1, wherein the skin is assembled to a network of heat pipes.

5- The device for dissipating heat as claimed in claim 1, wherein the dissipating panel comprises a planar internal skin and a planar external skin placed parallel to each other and rigidly connected using structural elements.

6- The device for dissipating heat as claimed in claim 5, wherein the structural elements are formed from a honeycomb configuration of aluminum tubes.

7- The device for dissipating heat as claimed in claim 5, wherein the structural elements are formed by a conductive foam.

8- The device for dissipating heat as claimed in claim 5, wherein the network of heat pipes is placed externally to the dissipating panel, on the surface of the internal skin.

9- The device for dissipating heat as claimed in claim 5, wherein the network of heat pipes is placed internally to the dissipating panel, between the internal skin and the external skin.

10- The device for dissipating heat as claimed in claim 1, wherein the network of heat pipes comprises one or a plurality of substantially tubular, aluminum heat pipes.

11- The device for dissipating heat as claimed in claim 1, wherein the network of heat pipes comprises one or a plurality of substantially tubular heat pipes formed from an aluminum alloy incorporating elements having low coefficients of thermal expansion.

12- The device for dissipating heat as claimed in claim 11, wherein the elements incorporated in the aluminum alloy are formed from a ceramic made of silicon carbide SiC or else of silicon nitride Si₃N₄.

13- The device for dissipating heat as claimed in claim 11, wherein the elements incorporated in the aluminum alloy are formed from silicon Si.

14- The device for dissipating heat as claimed in claim 11, wherein the elements incorporated in the aluminum alloy are formed from a ZrW₂O₈ ceramic.

15- The device for dissipating heat as claimed in claim 11, wherein the elements incorporated in the aluminum alloy are formed from β-eucryptite.

16- The device for dissipating heat as claimed in claim 8, wherein the heat pipes are assembled to the skins by means of the carbon-nanotube-enriched organic resin.

17- A fixed dissipating panel, for a satellite, formed from at least one heat-dissipating device as claimed in claim 1.

18- A deployable dissipating panel for a satellite, formed from at least one heat-dissipating device as claimed in claim 1.

19- A rack joined to a dissipating panel, for a satellite, formed from at least one heat-dissipating device as claimed in claim 1.
